(19) United States
(12) Patent Application Publication
(10) Pub. No.: US 2026/0065035 A1
(43) Pub. Date: Mar. 5, 2026

(54) GENERALIZED IMPLICIT REWARD FUNCTION FOR GENERATIVE ARTIFICIAL INTELLIGENCE

(71) Applicant: Salesforce, Inc., San Francisco, CA (US)

(72) Inventors: Bin Bi, Bellevue, WA (US); Shiva Kumar Pentyala, San Francisco, CA (US); James Zhu, San Francisco, CA (US); Sitaram Asur, San Francisco, CA (US); Na Cheng, Bellevue, WA (US); Zhichao Wang, San Francisco, CA (US)

(21) Appl. No.: 19/041,467

(22) Filed: Jan. 30, 2025

Related U.S. Application Data
(60) Provisional application No. 63/687,734, filed on Aug. 27, 2024.

(51) Int. Cl. G06N 3/0475; G06N 3/092

(52) U.S. Cl. CPC G06N 3/0475; G06N 3/092

(57) ABSTRACT

A method may include obtaining a generative artificial intelligence (AI) model that includes a set of weights and that is associated with an explicit reward model and an implicit reward model. The method may include zeroing a partition function of the implicit reward model. The method may include obtaining feedback data associated with the explicit reward model that includes preference feedback data, binary feedback data, score feedback data, or any combination thereof. The method may include generating the explicit reward model based on the feedback data. The method may include fine-tuning the set of weights of the generative AI model based on a comparison of the explicit reward model and the implicit reward model and further based on the feedback data. The method may include receiving a query and generating, based on the query and the fine-tuned set of weights, a response that is responsive to the query.

### CROSS REFERENCES

The present application for patent claims priority to U.S. Provisional Patent Application No. 63/687,734, by Bi et al., entitled “GENERALIZED IMPLICIT REWARD FUNCTION FOR GENERATIVE ARTIFICIAL INTELLIGENCE,” filed on Aug. 27, 2024, assigned to the assignee hereof, and expressly incorporated by reference herein.

### INCORPORATION BY REFERENCE

The present application is filed with an appendix that includes a document titled UNA: UNIFYING ALIGNMENTS OF RLHF/PPO, DPO AND KTO BY A GENERALIZED IMPLICIT REWARD FUNCTION. This document is hereby incorporated by reference in their entirety into the present application.

### FIELD OF TECHNOLOGY

The present disclosure relates generally to database systems and data processing, and more specifically to generalized implicit reward function for generative artificial intelligence.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

Generative artificial intelligence (AI) models may be trained through various techniques, including reinforcement learning. However, such techniques may be improved.

### BRIEF DESCRIPTION OF THE DRAWINGS

FIG. 1 illustrates an example of a data processing system that supports generalized implicit reward function for generative artificial intelligence in accordance with examples as disclosed herein.

FIG. 2 shows an example of a system that supports generalized implicit reward function for generative artificial intelligence in accordance with examples as disclosed herein.

FIG. 3 shows an example of a generative AI training scheme that supports generalized implicit reward function for generative artificial intelligence in accordance with examples as disclosed herein.

FIG. 4 shows an example of a process flow that supports generalized implicit reward function for generative artificial intelligence in accordance with examples as disclosed herein.

FIG. 5 shows a block diagram of an apparatus that supports generalized implicit reward function for generative artificial intelligence in accordance with examples as disclosed herein.

FIG. 6 shows a block diagram of a training manager that supports generalized implicit reward function for generative artificial intelligence in accordance with examples as disclosed herein.

FIG. 7 shows a diagram of a system including a device that supports generalized implicit reward function for generative artificial intelligence in accordance with examples as disclosed herein.

FIG. 8 shows a flowchart illustrating methods that support generalized implicit reward function for generative artificial intelligence in accordance with examples as disclosed herein.

### DETAILED DESCRIPTION

In some examples, generative AI models may be trained on trillions of tokens, but the quality of this pretrained data is not guaranteed. As a result, the pretrained generative artificial intelligence (AI) model may suffer from various deficiencies, including bias and ethical issues. Some approaches have employed the use of reinforcement learning (RL), such as reinforcement learning from human feedback (RLHF) and direct preference optimization (DPO). However, both approaches may include one or more limitations. For example, RLHF may involve training reward models and policies separately, which is complex, time-consuming, unstable during training processes, and may involve substantial memory burdens. Additionally, or alternatively, DPO may not make full usage of reward model information and may include restrictions on the alignment data (e.g., pairwise data).

The use of UNified Alignment (UNA) for fine-tuning of generative AI models is described, which may reduce or eliminate issues associated with RLHF, DPO, and other approaches to RL. UNA maps a reward model with a desired policy for the generative AI model and performs a supervised learning, including minimizing the difference between implicit reward and explicit reward. This may result in an improvement upon techniques individual RLHF and DPO techniques, simplify, stabilize, speed up and reduce the memory burden of RL fine-tuning processes (e.g., as used in RLHF), accommodate pairwise, binary or single responses for improving the reward models, and increase performance as compared with DPO, KTO, RLHF, and other approaches related to generative AI models.

Aspects of the disclosure are initially described in the context of an environment supporting an on-demand database service. Aspects of the disclosure are then described with reference to a system, a generative AI training scheme, and a process flow. Aspects of the disclosure are further illustrated by and described with reference to apparatus diagrams, system diagrams, and flowcharts that relate to generalized implicit reward function for generative artificial intelligence.

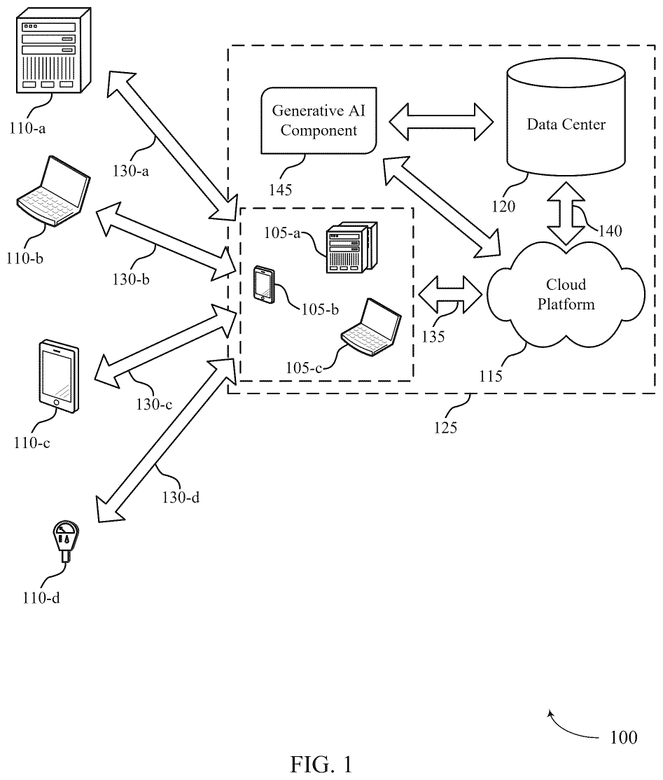

FIG. 1 illustrates an example of a system 100 for cloud computing that supports generalized implicit reward function for generative artificial intelligence in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

The use of RLHF may suffer from various technical problems. For example, overfitting problems are often faced in the training stage of reward models. In addition, the RL fine-tuning stage is inherently unstable due to the nature of RL. Also, RLHF may increase the amount of memory used for elements such as a policy, reference policy, reward models, and value models. Similarly, DPO has its own set of challenges. For example, DPO cannot produce an explicit reward model and may involve the use of more preference data to finetune the generative AI model. Moreover, in other approaches besides DPO, the use of a pretrained reward model may provide accurate guidance for alignment, which is absent in DPO. Additionally, or alternatively, the efficiency of DPO in using preference data is reduced.

The use of UNA may offer simplified techniques, such as by replacing the original RL fine-tuning stage, which is unstable, slow, and memory-intensive with a stable, efficient and memory friendly supervised learning stage. In addition, UNA can accommodate different types of data including pairwise feedback, binary feedback, score-based feedback. For example, given a prompt and response, UNA techniques may involve calculating the implicit reward and performing a supervised learning process to minimize the difference between the implicit reward and the explicit reward, thereby reducing or eliminating the issues present with other approaches.

It should be appreciated by a person skilled in the art that one or more aspects of the disclosure may be implemented in a system 100 to additionally, or alternatively, solve other problems than those described herein. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

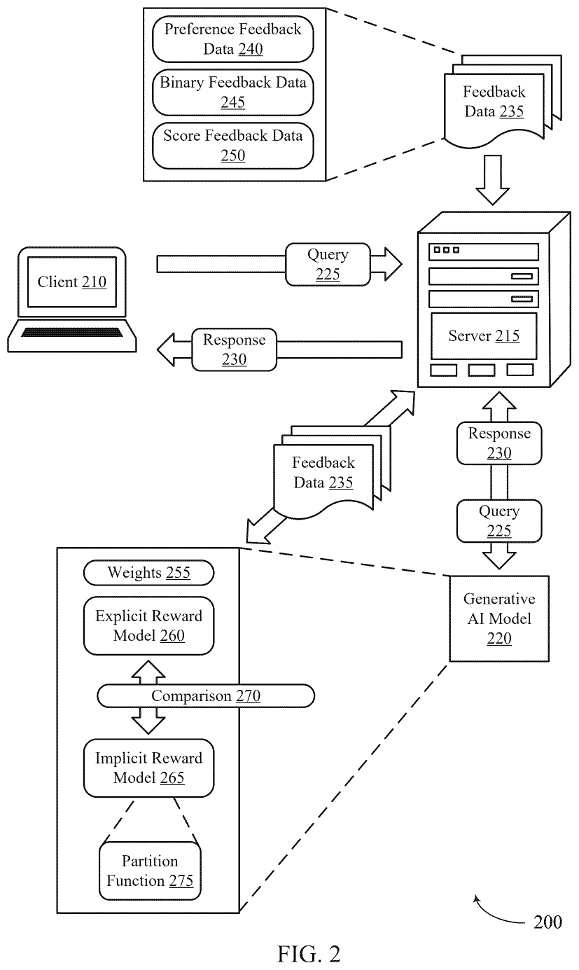

FIG. 2 shows an example of a system 200 that supports generalized implicit reward function for generative artificial intelligence in accordance with examples as disclosed herein.

Generative AI models may be pretrained with many corpuses to gain strong capabilities. However, in some examples, the quality of the corpus cannot be guaranteed, potentially including biased and unethical information. As a result, during inference processing, a generative AI model can generate bias or unethical responses, which should be avoided. Though supervised fine-tuning (SFT) can improve generative AI models on downstream tasks like question answering, it cannot solve the bias and ethical problems. To solve this problem, RLHF may be employed. RLHF may involve two stages of training from the SFT models. In some examples of RLHF, a system may train a reward model (RM) using a preference dataset including of tuples (e.g., including an input, desired response, and undesired response). Next, during the RL fine-tuning stage, the policy may generate responses to given prompts. These responses may be evaluated by the pretrained reward model and then used to fine-tune the policy with RL through proximal policy optimization (PPO).

However, several problems exist in RLHF. To begin with, overfitting problems may be faced in the training stage of the reward model. In addition, the RL fine-tuning stage may be inherently unstable due to the nature of RL. Lastly, RL increases memory involve considerations for the policy, reference policy, reward model, and value model, among other elements.

In some examples, DPO may be employed to address some of these issues by creating a mapping between the reward model and a desired policy, combining the RM and RL training stages into a single process. This approach simplifies the two-stage processing into one stage, eliminating the aspect of training an explicit reward model, reducing memory costs, and transforming the unstable RL process into a stable binary classification problem. Given a prompt along with desired and undesired responses, the implicit rewards for both responses are calculated. The differences in these rewards are then used to optimize the policy.

However, DPO has its own set of challenges. It cannot produce an explicit reward model and will involve more preference data to fine-tune the generative AI model. Moreover, in RL, the pretrained RM can provide accurate guidance for alignment, which is absent in DPO. Further, DPO's efficiency in using preference data is lower compared to RLHF and/or PPO.

In some examples, KTO may be employed to extend DPO to handle binary data, such as thumbs up and thumbs down for desired and undesired responses. However, DPO does not address alignment based on a prompt and response, as well as corresponding evaluation scores.

To reduce or eliminate such issues with other techniques, UNA may be employed, which unifies RLHF and PPO with DPO and combines the benefits of them.

For example, based on an objective shown in Equation 1, a desired policy (e.g., an optimal policy) may be induced by

$$r ( x , y ) = βlog ( \frac{{π}_{θ} ( y \vert x )}{{π}_{ref} ( y \vert x )} ) + f ( x ) + c ,$$

which may be further simplified to

$$r ( x , y ) = βlog ( \frac{{π}_{θ} ( y \vert x )}{{π}_{ref} ( y \vert x )} )$$

when f(x)=c=0.

$${π}_{θ}^{*} ( y \vert x ) = {max}_{{π}_{θ}} {E}_{x ∼ D} \{ {E}_{y ∼ {π}_{θ}} [ {r}_{θ} ] ( x , y ) ] - β {D}_{KL} ( {π}_{θ} ( y \vert x ) ‖ {π}_{ref} ( y \vert x ) ) \} \qquad ( 1 )$$

Based on such a generalized implicit reward function, UNA unifies RLHF/PPO with DPO into a supervised learning of minimizing the difference between implicit reward and explicit reward. In some examples, the explicit reward may be obtained from human labelers, reward functions, and generative AI models. Given a prompt, the trained policy can firstly generate responses, and an implicit reward score can be calculated based on Equation 1. Then, the pair of prompt and response is evaluated by different evaluation tools to derive an explicit reward score. Provided the implicit and explicit reward score, a supervised learning problem like mean square error (MSE) can be constructed to unify RLHF and DPO. In some examples, for clarity, the unnormalized evaluation is termed as reward and the normalized evaluation is termed as score in this work.

With UNA, RLHF can be simplified through replacing the original RL fine-tuning stage, which is unstable, slow, and memory-intensive with a stable, efficient and memory friendly supervised learning. In addition, UNA can accommodate different types of data including pairwise feedback, binary feedback, score-based feedback. For pairwise data, we it may be shown that UNA and DPO are equivalent. For binary data, thumbs up (positive feedback) and thumbs down (negative feedback) can be regarded as explicit rewards with reward scores of 1 and 0 respectively. With these derived implicit and explicit rewards, UNA can accommodate binary feedback. Lastly, for any types of unpaired data composed of a tuple, such as a tuple of (prompt, response, score), UNA can be applied. Given the prompt and response, the implicit reward is firstly calculated, and then a supervised learning process is conducted to minimize the difference between the implicit reward and the explicit reward, which may be referred to as the score. Thus, it may be seen that UNA is an improvement over RLHF and DPO that is simplified and can accommodate different data types.

For example, the system 200 may perform a fine-tuning of a generative AI model 220 using one or more techniques. For example, the system 200 (e.g., through actions performed through the server 215) may receive, generate, or otherwise obtain a generative AI model 220. The generative AI model 220 may be a trained model that may include a set of weights 255. Further, the generative AI model 220 may be associated with an explicit reward model 260 and an implicit reward model 265. In some examples, the system 200 may generate the explicit reward model 260, the implicit reward model 265, or both. In some examples, the system 200 may generate the explicit reward model 260, the implicit reward model 265, or both, based at least in part on the feedback data 235, such as the preference feedback data 240, the binary feedback data 245, the score feedback data 250, other feedback data, or any combination thereof. Additionally, or alternatively, the system 200 may be provided with the explicit reward model 260, the implicit reward model 265, or both, and such provided models may be adjusted or refined by the system 200 (e.g., through techniques described herein).

In some examples, the implicit reward model 265 may be represented by Equation 2 described herein, where r_{θ}(x,y) represents the implicit reward function, π_{θ}(y|x) represents a policy associated with the generative AI model 220, π_{ref}(y|x) a reference policy, and Z(x) represents the partition function.

$${r}_{θ} ( x , y ) = βlog ( \frac{{π}_{θ} ( y \vert x )}{{π}_{ref} ( y \vert x )} ) + βlog Z ( x ) \qquad ( 2 )$$

In some examples, the system 200 may zero, cancel out, nullify, or remove a partition function 275 that is associated with the implicit reward model 265. As a result, Equation 2 may be modified to result in Equation 3. By forcing the partition function 275 to be zero, the implicit reward function may then accommodate different types of feedback data 235, such as the preference feedback data 240, the binary feedback data 245, the score feedback data 250, other feedback data, or any combination thereof.

$${r}_{θ} ( x , y ) = βlog ( \frac{{π}_{θ} ( y \vert x )}{{π}_{ref} ( y \vert x )} ) \qquad ( 3 )$$

In some examples, the system 200 may obtain the feedback data 235, including the preference feedback data 240, the binary feedback data 245, the score feedback data 250, other feedback data, or any combination thereof. The system 200 may further, in some examples, generate the explicit reward model 260 based at least in part on the feedback data.

In some examples, the system 200 may fine-tune the set of weights 255 of the generative AI model 220. For example, the system 200 may make a comparison 270 between the explicit reward model 260 and the implicit reward model 265. The system 200 may measure or determine a difference or difference measurement between the explicit reward model 260 and the implicit reward model 265. Such a difference or difference measurement may be a binary cross entropy calculation, a mean squared error calculation, one or more other difference metrics or measurements, or any combination thereof. Further, the system 200 may adjust one or more aspects, parameters, or values of the explicit reward model 260, the implicit reward model 265, the weights 255, one or more other parameters associated with the generative AI model 220, or any combination thereof, to reduce the difference (e.g., based on the difference measurement) between the explicit reward model 260 and the implicit reward model 265. In some examples, the adjustment to reduce the difference measurement may be based at least in part on the feedback data 235.

In some examples, after or in response to fine-tuning the set of weights 255 or other aspects of the generative AI model 220, the system 200 may receive (e.g., via the server 215) a query 225 from the client 210. The query 225 may be processed by the server 215 (e.g., to augment or modify the query 225) and may pass the query to the generative AI model 220. The generative AI model 220 may process the query 225 and may generate a response 230 to the query 225 (e.g., based on the weights 255, the explicit reward model 260, the implicit reward model 265, the weights 255, one or more other parameters associated with the generative AI model 220, the feedback data 235, or any combination thereof).

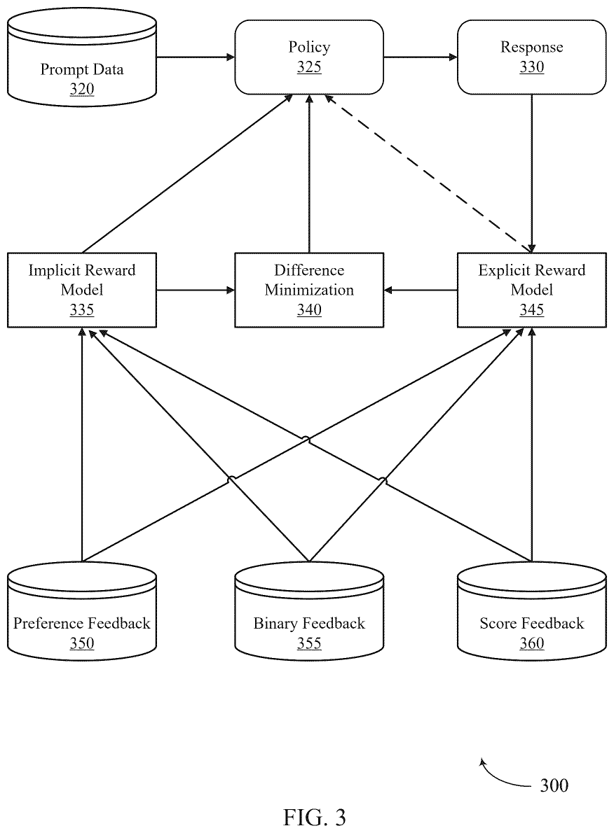

FIG. 3 shows an example of a generative AI training scheme 300 that supports generalized implicit reward function for generative artificial intelligence in accordance with examples as disclosed herein.

In some examples, RLHF using PPO may include two main stages: 1) reward model training and 2) reinforcement learning fine-tuning. During the reward model training process, an explicit reward model is trained to predict a reward score based on a given prompt x and response y. This training utilizes pairwise preference data in the form of tuples, e.g., (x, yw, yl)), where yw represents the desired response and yl represents the undesired response. Initially, the probability of yw being preferred over yl may be calculated based on their respective reward scores through the Bradley-Terry (BT) model, which provides a probabilistic framework for comparing the preferences between the two responses.

In some examples, a pre-collected pairwise dataset where humans have selected the desired and undesired responses from two candidates may be employed. To train an effective reward model, the cross-entropy loss between the predicted probabilities and the human-labeled probabilities may be minimized or reduced. Once the cross-entropy loss is minimized, the training of the reward model is complete.

The second stage of RL fine-tuning may include two primary goals. The first goal may be to maximize the pre-trained explicit reward function to ensure the policy aligns with desired outcomes. In some examples, to prevent or dissuade reward hacking, the KL divergence from the initial policy may be incorporated.

However, several limitations exist in RLHF. To begin with, the reward model may suffer from overfitting during training, which can adversely affect the RL fine-tuning process. Further, in some examples, unlink traditional supervised learning, RL does not have explicit labels for each prompt and response. In some examples, PPO may be employed to optimize the RL objective. However, even with PPO, RL training can still be unstable. Additionally, RLHF with PPO necessitates the use of a policy, reference policy, reward model, and value model, which significantly increases memory involvements, especially for generative AI models.

In RLHF, the trained reward model can suffer from overfitting, and RL fine-tuning is notorious for its instability and memory intensity. To address these challenges, DPO may be used and it may be determined that a desired policy (e.g., an optimal policy) for a reward function can be derived. With the derived implicit reward model, it can be plugged into the reward model training process of RLHF. By optimizing the loss function in DPO, it may be possible to eliminate the need for an explicit reward model and combine the two stages of RLHF into a single, streamlined process, greatly simplifying the RLHF/PPO workflow.

However, DPO has several limitations. First, the partition function Z(x) cannot be directly estimated, which means only pairwise preference data can be utilized, making single-prompt data unusable during the RL fine-tuning stage. Additionally, while pairwise preference data are typically used in the reward model stage, DPO may involve their use throughout, leading to inefficient use of pre-collected data. In comparison, after reward model training, it can be applied to prompt data. Lastly, in the RL stage in RLHF, reward model can provide more detailed evaluations of the generated responses. However, DPO may not offer this level of granularity during training.

However, the use of UNA may provide a new relationship between the reward model and the optimal policy. In some examples, by adhering to the same objective outlined in RLHF, it may be possible to formulate a novel connection between the implicit reward function and a desirable policy 325. Such a reward formulation may imply that it may be possible to transform the original unstable, memory-expensive RL training process into a reward function optimization problem, which may be a stable and memory-efficient supervised learning process. For example, Equation 4 herein may describe such a connection between the implicit reward model 335 and the policy 325.

$${r}_{θ} ( x , y ) = βlog ( \frac{{π}_{θ} ( y \vert x )}{{π}_{ref} ( y \vert x )} ) + f ( x ) + C = βlog ( \frac{{π}_{θ} ( y \vert x )}{{π}_{ref} ( y \vert x )} ) when f ( x ) = 0 and c = 0 \qquad ( 4 )$$

In some examples, the explicit reward model 345 can be derived from multiple methods or sources, such as human-labeled data and/or analysis, pretrained generative AI model analysis, or pretrained reward model analysis. In some examples, the RL fine-tuning process may be transformed into a general minimization problem (e.g., the difference minimization 340) between explicit reward and implicit reward, which may consider, include, or involve a general function that measure the difference between x and y, like mean-squared error (MSE). Such a comparison may be shown in Equation 5 herein, where r_{φ}(x,y) represents the explicit reward model 345 and r_{θ}(x,y) represents the implicit reward model 335.

$${L}_{UNA - reward ( {π}_{θ} )} = {E}_{x ∼ D} {E}_{y ∼ {π}_{θ} ( \cdot \vert x )} [ g ( {r}_{ϕ} ( x , y ) , {r}_{θ} ( x , y ) ) ] \qquad ( 5 )$$

In some examples, explicit evaluations can be obtained from generative AI model assessments, resulting in scores within a specific range, such as [0, 100]. These scores can be easily normalized to the interval [0, 1]. However, the explicit and implicit reward function can span from negative to positive infinity. To normalize implicit reward, the implicit score function can be derived as shown in Equation 6. For clarity, in some examples, the unnormalized evaluation is termed as reward and the normalized evaluation is termed as score.

$${s}_{θ} ( x , y ) = σ [ {r}_{θ} ( x , y ) ] = σ [ βlog \frac{{π}_{θ} ( y \vert x )}{{π}_{ref} ( y \vert x )} ] \qquad ( 6 )$$

Given the implicit and explicit score function, an equivalent general loss function for UNA may be obtained, which may be shown in Equation 7 herein. In some examples, this general loss function using the new implicit reward function, may be utilized in multiple conditions, including equal or improved performance as DPO for pairwise preference dataset, equal or improved performance for Kahneman-Tversky Optimization (KTO) for binary feedback, RM/generative AI model distillation using reward from RM/generative AI models, and simplification of RLHF in RL fine-tuning stage, including replacement of PPO with a supervised learning process.

$${L}_{UNA - score ( {π}_{θ} )} = {𝔼}_{x ∼ D} {𝔼}_{y ∼ {π}_{θ} ( \cdot \vert x )} [ g ( {s}_{ϕ} ( x , y ) , {s}_{θ} ( x , y ) ) ] \qquad ( 7 )$$

In some examples, the generative AI training scheme 300 may involve the use of the prompt data 320, which may be processed based on the policy 325 to produce the response 330. Further, both an implicit reward model 335 and an explicit reward model 345 may be used to modify a reward model (e.g., the implicit reward model 335, the explicit reward model 345, or both), the policy 325, or both. In some examples, the difference minimization 340 may be performed to reduce or minimize the difference (e.g., an MSE or other measure of distance) between the implicit reward model 335 and the explicit reward model 345. Based on the reduction or minimization, one or more parameters (e.g., of the implicit reward model 335, the explicit reward model 345, the policy 325, another reward model, one or more other elements, or any combination thereof) may be modified to produce an improved policy 325, which may then be used to generate the response 330 to the prompt data 320.

In some examples, the preference feedback 350, the binary feedback 355, the score feedback 360, other feedback information, or any combination thereof, may be employed to generate or modify the implicit reward model 335, the explicit reward model 345, or both. The capability of UNA to utilize these and other types of data is an improvement to generative AI model technology as compared to other approaches.

Thus, the use of UNA may be shown to have at least the same performance, if not improved performance, as compared to other approaches. For example, UNA may be considered to be an improvement to DPO for pairwise datasets. For pairwise dataset, the implicit rewards of desired and undesired responses can be derived. Then, the target should lie in maximizing the difference of implicit rewards between desired and undesired responses.

Additionally, or alternatively, UNA may be considered to be an improvement to KTO for binary feedback. For example, for use in UNA, the positive and negative feedback of binary preference data can be transformed to explicit scores. For example, positive or ‘thumb up’ data can be assigned a reward score of 1. In contrast, a negative or ‘thumb down’ data can be assigned a reward score of 0. Because the explicit feedback is binary (e.g., a score rather than a reward), an implicit score may be utilized. Based on the implicit and explicit scores, multiple loss functions can be designed using mean square error (MSE) or binary cross entropy. Thus, UNA can be utilized to replace KTO for binary feedback data, and it may outperform KTO.

Additionally, or alternatively, UNA may be applied in situations in which generative AI models/reward models distillation is used. In other approaches, some have utilized generative AI models and reward models to evaluate responses by outputting scores and rewards according to predefined standards. If the score and reward evaluations are accurate enough, they can be extra information to be utilized for alignment. However, the explicit reward and score from the reward model and generative AI model usage is not binary, and as a result, it may not be possible to utilize BCE utilized for a loss function (e.g., as opposed to using either or both of MSE and BCE). Further, loss functions for UNA using generative AI model distillation and UNA using reward model distillation may be improved as compared with other approaches. In particular, when utilizing generative AI model for evaluation, it can be regarded as method for generative AI model distillation. In comparison, when utilizing reward model for evaluation, it can be regarded as a simplified offline RLHF or RM distillation.

Additionally, or alternatively, UNA is simpler than RLHF while providing increased performance. For example, when utilizing a reward model for online evaluation, UNA may greatly simplify RL fine-tuning stage of RLHF and PPO with superior performances. Assuming the reward model has already been trained, the focus may shift to the RL fine-tuning stage. The original RL objective from RLHF may be transformed to MSE of implicit reward and explicit reward of a loss function of UNA generative AI model distillation, as well as the explicit score of a loss function of UNA reward model distillations.

UNA has several benefits over RLHF/PPO. To begin with, it transforms the original unstable RL problem into a stable supervised learning problem by minimizing the difference between implicit and explicit rewards. In addition, UNA removes the use of value models present in PPO, and partially reduce the burden of memory cost. Then, the computation cost of MSE is much lower compared with the multiple terms in PPO to maintain performance, and as a result, UNA will speed up the training process. Further, on downstream tasks, UNA outperforms RLHF/PPO.

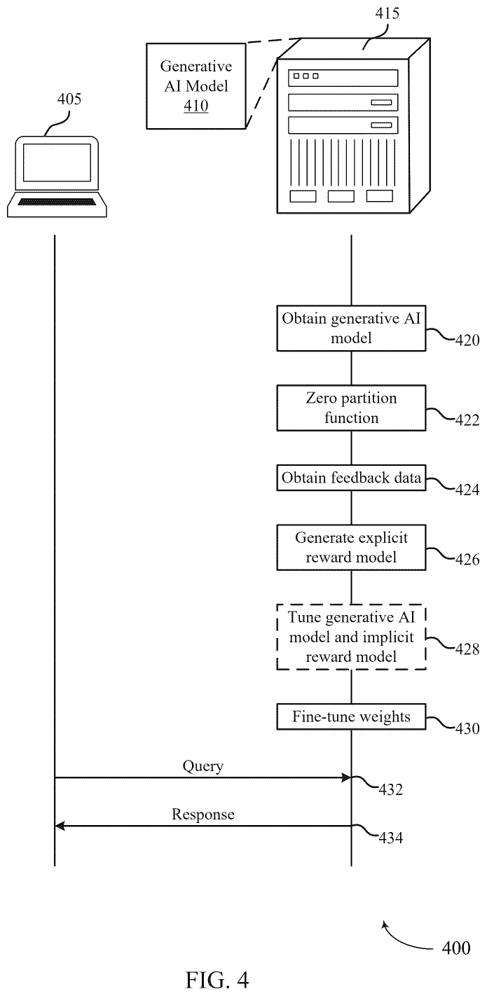

FIG. 4 shows an example of a process flow 400 that supports generalized implicit reward function for generative artificial intelligence in accordance with examples as disclosed herein. The process flow 400 may implement various aspects of the present disclosure described herein. The elements described in the process flow 400 (e.g., server 415, client 405, and generative AI model 410) may be examples of similarly named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the server 415 may obtain a generative AI model 410 that is a trained model that may include a set of weights and that is associated with an explicit reward model and an implicit reward model.

At 422, the server 415 may zero a partition function of the implicit reward model associated with the generative AI model 410.

At 424, the server 415 may obtain feedback data associated with the explicit reward model, the feedback data that may include preference feedback data, binary feedback data, score feedback data, or any combination thereof. In some examples, the feedback data may include a plurality of feedback prompts and a plurality of feedback responses to the plurality of feedback prompts. In some examples, the preference feedback data may include indications of preferred responses and non-preferred responses of the plurality of feedback responses. In some examples, the binary feedback data may include positive indications and negative indications to the plurality of feedback prompts, positive indications and the negative indications included in the plurality of feedback responses. In some examples, the score feedback data may include scoring information that is included in the plurality of feedback responses.

At 426, the server 415 may generate the explicit reward model based on the feedback data.

At 428, the server 415 may tune the generative AI model 410 and the implicit reward model based on a relationship between the generative AI model 410 and the implicit reward model. In some examples, the relationship relates the implicit reward model, the generative AI model 410, a reference policy associated with the generative AI model 410, and the partition function. In some examples, zeroing the partition function may include zeroing the partition function with respect to the relationship.

At 430, the server 415 may fine-tune the set of weights of the generative AI model 410 based on a comparison of the explicit reward model and the implicit reward model and further based on the feedback data. In some examples, to fine-tune the generative AI model 410, the server 415 may reduce a difference between the explicit reward model and the implicit reward model based on the comparison of the explicit reward model and the implicit reward model. In some examples, the comparison may include a mean-squared error comparison or a binary cross entropy comparison. In some examples, fine-tuning the set of weights is based on a reduction in the mean-squared error comparison or the binary cross entropy comparison. In some examples, the server 415 may fine-tune the set of weights of the generative AI model 410 in a single pass.

At 432, the server 415 may receive (e.g., from the client 405), a query. In some examples, the server 415 may transmit the query to the generative AI model 410.

At 434, the server 415 may generate, with the generative AI model 410 and based on the query and the fine-tuned set of weights, a response that is responsive to the query. In some examples, the server 415 may transmit the response to the client 405.

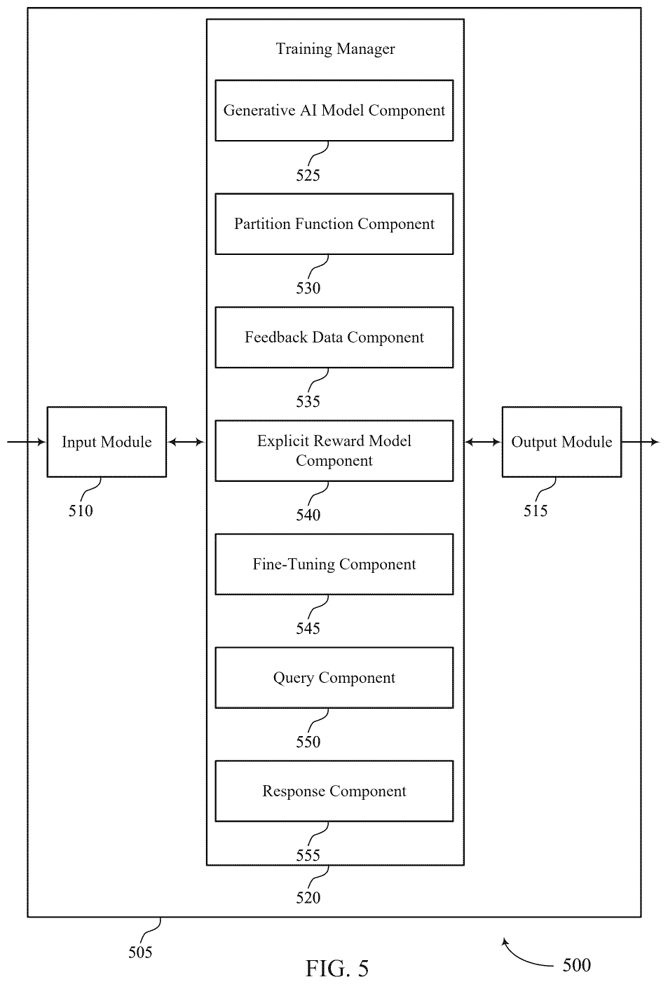

FIG. 5 shows a block diagram 500 of a device 505 that supports generalized implicit reward function for generative artificial intelligence in accordance with examples as disclosed herein. The device 505 may include an input module 510, an output module 515, and a training manager 520. The device 505, or one or more components of the device 505 (e.g., the input module 510, the output module 515, the training manager 520), may include at least one processor, which may be coupled with at least one memory, to support the described techniques. Each of these components may be in communication with one another (e.g., via one or more buses).

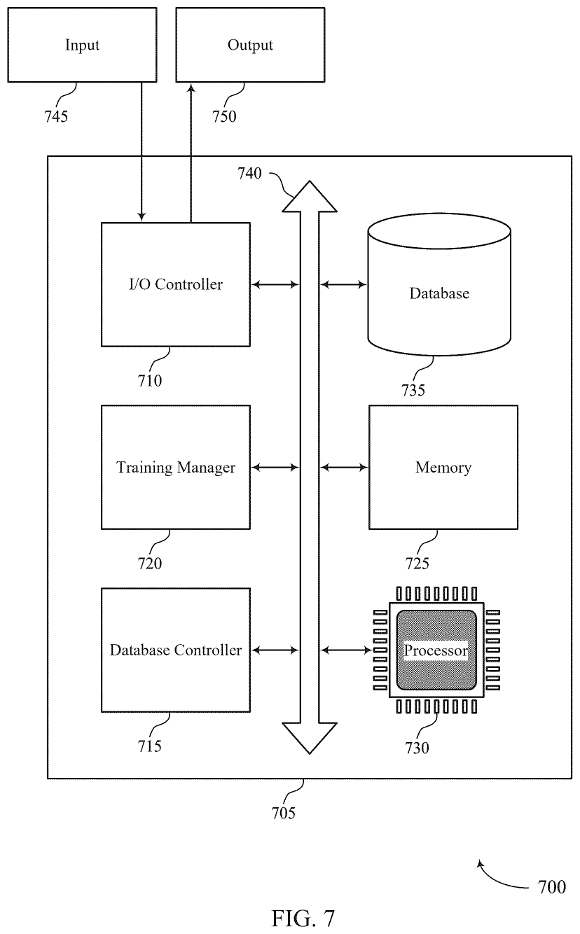

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the training manager 520 to support generalized implicit reward function for generative artificial intelligence. In some cases, the input module 510 may be a component of an input/output (I/O) controller 710 as described with reference to FIG. 7.

The output module 515 may manage output signals for the device 505. For example, the output module 515 may receive signals from other components of the device 505, such as the training manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the training manager 520 may include a generative AI model component 525, a partition function component 530, a feedback data component 535, an explicit reward model component 540, a fine-tuning component 545, a query component 550, a response component 555, or any combination thereof. In some examples, the training manager 520, or various components thereof, may be configured to perform various operations (e.g., receiving, monitoring, transmitting) using or otherwise in cooperation with the input module 510, the output module 515, or both. For example, the training manager 520 may receive information from the input module 510, send information to the output module 515, or be integrated in combination with the input module 510, the output module 515, or both to receive information, transmit information, or perform various other operations as described herein.

The training manager 520 may support data processing in accordance with examples as disclosed herein. The generative AI model component 525 may be configured to support obtaining a generative AI model that is a trained model including a set of weights and that is associated with an explicit reward model and an implicit reward model. The partition function component 530 may be configured to support zeroing a partition function of the implicit reward model associated with the generative AI model. The feedback data component 535 may be configured to support obtaining feedback data associated with the explicit reward model, the feedback data including preference feedback data, binary feedback data, score feedback data, or any combination thereof. The explicit reward model component 540 may be configured to support generating the explicit reward model based on the feedback data. The fine-tuning component 545 may be configured to support fine-tuning the set of weights of the generative AI model based on a comparison of the explicit reward model and the implicit reward model and further based on the feedback data. The query component 550 may be configured to support receiving, at the generative AI model, a query. The response component 555 may be configured to support generating, with the generative AI model and based on the query and the fine-tuned set of weights, a response that is responsive to the query.

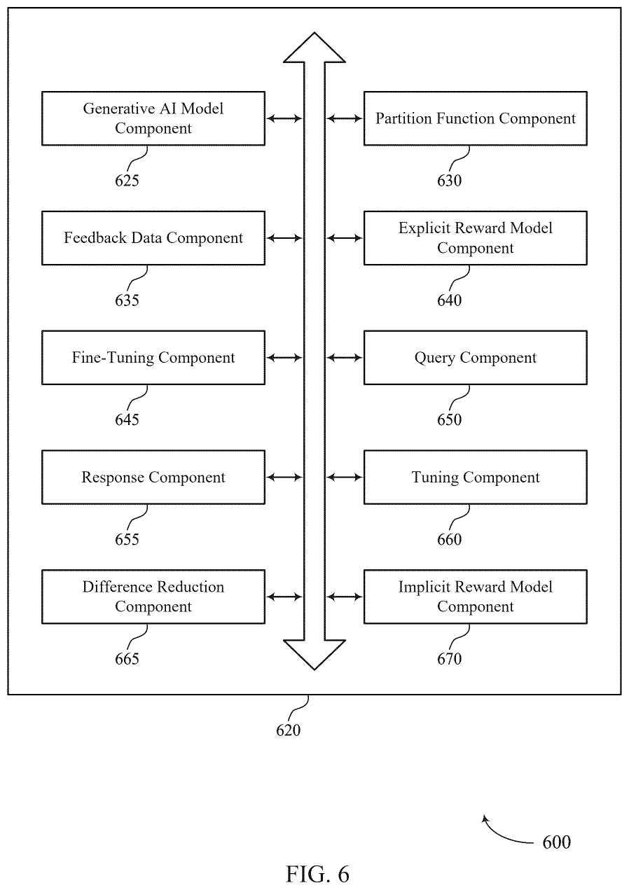

FIG. 6 shows a block diagram 600 of a training manager 620 that supports generalized implicit reward function for generative artificial intelligence in accordance with examples as disclosed herein. The training manager 620 may be an example of aspects of a training manager or a training manager 520, or both, as described herein. The training manager 620, or various components thereof, may be an example of means for performing various aspects of generalized implicit reward function for generative artificial intelligence as described herein. For example, the training manager 620 may include a generative AI model component 625, a partition function component 630, a feedback data component 635, an explicit reward model component 640, a fine-tuning component 645, a query component 650, a response component 655, a tuning component 660, a difference reduction component 665, an implicit reward model component 670, or any combination thereof. Each of these components, or components of subcomponents thereof (e.g., one or more processors, one or more memories), may communicate, directly or indirectly, with one another (e.g., via one or more buses).

The training manager 620 may support data processing in accordance with examples as disclosed herein. The generative AI model component 625 may be configured to support obtaining a generative AI model that is a trained model including a set of weights and that is associated with an explicit reward model and an implicit reward model. The partition function component 630 may be configured to support zeroing a partition function of the implicit reward model associated with the generative AI model. The feedback data component 635 may be configured to support obtaining feedback data associated with the explicit reward model, the feedback data including preference feedback data, binary feedback data, score feedback data, or any combination thereof. The explicit reward model component 640 may be configured to support generating the explicit reward model based on the feedback data. The fine-tuning component 645 may be configured to support fine-tuning the set of weights of the generative AI model based on a comparison of the explicit reward model and the implicit reward model and further based on the feedback data. The query component 650 may be configured to support receiving, at the generative AI model, a query. The response component 655 may be configured to support generating, with the generative AI model and based on the query and the fine-tuned set of weights, a response that is responsive to the query.

In some examples, the tuning component 660 may be configured to support tuning the generative AI model and the implicit reward model based on a relationship between the generative AI model and the implicit reward model.

In some examples, the relationship relates the implicit reward model, the generative AI model, a reference policy associated with the generative AI model, and the partition function. In some examples, zeroing the partition function includes zeroing the partition function with respect to the relationship.

In some examples, to support fine-tuning the set of weights, the difference reduction component 665 may be configured to support reducing a difference between the explicit reward model and the implicit reward model based on the comparison of the explicit reward model and the implicit reward model.

In some examples, the comparison includes a mean-squared error comparison or a binary cross entropy comparison. In some examples, fine-tuning the set of weights is based on a reduction in the mean-squared error comparison or a binary cross entropy comparison.

In some examples, the explicit reward model component 640 may be configured to support generating the explicit reward model based on the feedback data.

In some examples, the feedback data includes a set of multiple feedback prompts and a set of multiple feedback responses to the set of multiple feedback prompts. In some examples, the preference feedback data includes indications of preferred responses and non-preferred responses of the set of multiple feedback responses. In some examples, the binary feedback data includes positive indications and negative indications to the set of multiple feedback prompts, positive indications and the negative indications included in the set of multiple feedback responses. In some examples, the score feedback data includes scoring information that is included in the set of multiple feedback responses.

In some examples, the fine-tuning component 645 may be configured to support fine-tuning the set of weights of the generative AI model in a single pass.

FIG. 7 shows a diagram of a system 700 including a device 705 that supports generalized implicit reward function for generative artificial intelligence in accordance with examples as disclosed herein. The device 705 may be an example of or include components of a device 505 as described herein. The device 705 may include components for bi-directional data communications including components for transmitting and receiving communications, such as a training manager 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting generalized implicit reward function for generative artificial intelligence). The processor 730 may be an example of a single processor or multiple processors. For example, the device 705 may include one or more processors 730.

The training manager 720 may support data processing in accordance with examples as disclosed herein. For example, the training manager 720 may be configured to support obtaining a generative AI model that is a trained model including a set of weights and that is associated with an explicit reward model and an implicit reward model. The training manager 720 may be configured to support zeroing a partition function of the implicit reward model associated with the generative AI model. The training manager 720 may be configured to support obtaining feedback data associated with the explicit reward model, the feedback data including preference feedback data, binary feedback data, score feedback data, or any combination thereof. The training manager 720 may be configured to support generating the explicit reward model based on the feedback data. The training manager 720 may be configured to support fine-tuning the set of weights of the generative AI model based on a comparison of the explicit reward model and the implicit reward model and further based on the feedback data. The training manager 720 may be configured to support receiving, at the generative AI model, a query. The training manager 720 may be configured to support generating, with the generative AI model and based on the query and the fine-tuned set of weights, a response that is responsive to the query.

By including or configuring the training manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

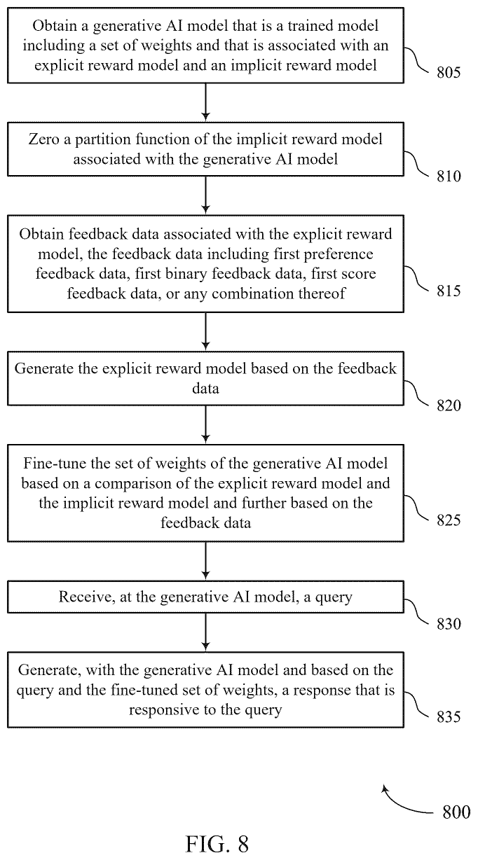

FIG. 8 shows a flowchart illustrating a method 800 that supports generalized implicit reward function for generative artificial intelligence in accordance with examples as disclosed herein. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 805, the method may include obtaining a generative AI model that is a trained model including a set of weights and that is associated with an explicit reward model and an implicit reward model. The operations of 805 may be performed in accordance with examples as disclosed herein. In some examples, aspects of the operations of 805 may be performed by a generative AI model component 625 as described with reference to FIG. 6.

At 810, the method may include zeroing a partition function of the implicit reward model associated with the generative AI model. The operations of 810 may be performed in accordance with examples as disclosed herein. In some examples, aspects of the operations of 810 may be performed by a partition function component 630 as described with reference to FIG. 6.

At 815, the method may include obtaining feedback data associated with the explicit reward model, the feedback data including preference feedback data, binary feedback data, score feedback data, or any combination thereof. The operations of 815 may be performed in accordance with examples as disclosed herein. In some examples, aspects of the operations of 815 may be performed by a feedback data component 635 as described with reference to FIG. 6.

At 820, the method may include generating the explicit reward model based on the feedback data. The operations of 820 may be performed in accordance with examples as disclosed herein. In some examples, aspects of the operations of 820 may be performed by an explicit reward model component 640 as described with reference to FIG. 6.

At 825, the method may include fine-tuning the set of weights of the generative AI model based on a comparison of the explicit reward model and the implicit reward model and further based on the feedback data. The operations of 825 may be performed in accordance with examples as disclosed herein. In some examples, aspects of the operations of 825 may be performed by a fine-tuning component 645 as described with reference to FIG. 6.

At 830, the method may include receiving, at the generative AI model, a query. The operations of 830 may be performed in accordance with examples as disclosed herein. In some examples, aspects of the operations of 830 may be performed by a query component 650 as described with reference to FIG. 6.

At 835, the method may include generating, with the generative AI model and based on the query and the fine-tuned set of weights, a response that is responsive to the query. The operations of 835 may be performed in accordance with examples as disclosed herein. In some examples, aspects of the operations of 835 may be performed by a response component 655 as described with reference to FIG. 6.

A method for data processing by an application server is described. The method may include obtaining a generative AI model that is a trained model including a set of weights and that is associated with an explicit reward model and an implicit reward model, zeroing a partition function of the implicit reward model associated with the generative AI model, obtaining feedback data associated with the explicit reward model, the feedback data including preference feedback data, binary feedback data, score feedback data, or any combination thereof, generating the explicit reward model based on the feedback data, fine-tuning the set of weights of the generative AI model based on a comparison of the explicit reward model and the implicit reward model and further based on the feedback data, receiving, at the generative AI model, a query, and generating, with the generative AI model and based on the query and the fine-tuned set of weights, a response that is responsive to the query.

An application server for data processing is described. The application server may include one or more memories storing processor executable code, and one or more processors coupled with the one or more memories. The one or more processors may individually or collectively be operable to execute the code to cause the application server to obtain a generative AI model that is a trained model including a set of weights and that is associated with an explicit reward model and an implicit reward model, zero a partition function of the implicit reward model associated with the generative AI model, obtain feedback data associated with the explicit reward model, the feedback data including preference feedback data, binary feedback data, score feedback data, or any combination thereof, generate the explicit reward model based on the feedback data, fine-tune the set of weights of the generative AI model based on a comparison of the explicit reward model and the implicit reward model and further based on the feedback data, receive, at the generative AI model, a query, and generate, with the generative AI model and based on the query and the fine-tuned set of weights, a response that is responsive to the query.

Another application server for data processing is described. The application server may include means for obtaining a generative AI model that is a trained model including a set of weights and that is associated with an explicit reward model and an implicit reward model, means for zeroing a partition function of the implicit reward model associated with the generative AI model, means for obtaining feedback data associated with the explicit reward model, the feedback data including preference feedback data, binary feedback data, score feedback data, or any combination thereof, means for generating the explicit reward model based on the feedback data, means for fine-tuning the set of weights of the generative AI model based on a comparison of the explicit reward model and the implicit reward model and further based on the feedback data, means for receiving, at the generative AI model, a query, and means for generating, with the generative AI model and based on the query and the fine-tuned set of weights, a response that is responsive to the query.

A non-transitory computer-readable medium storing code for data processing is described. The code may include instructions executable by one or more processors to obtain a generative AI model that is a trained model including a set of weights and that is associated with an explicit reward model and an implicit reward model, zero a partition function of the implicit reward model associated with the generative AI model, obtain feedback data associated with the explicit reward model, the feedback data including preference feedback data, binary feedback data, score feedback data, or any combination thereof, generate the explicit reward model based on the feedback data, fine-tune the set of weights of the generative AI model based on a comparison of the explicit reward model and the implicit reward model and further based on the feedback data, receive, at the generative AI model, a query, and generate, with the generative AI model and based on the query and the fine-tuned set of weights, a response that is responsive to the query.

Some examples of the method, application servers, and non-transitory computer-readable medium described herein may further include operations, features, means, or instructions for tuning the generative AI model and the implicit reward model based on a relationship between the generative AI model and the implicit reward model.

In some examples of the method, application servers, and non-transitory computer-readable medium described herein, the relationship relates the implicit reward model, the generative AI model, a reference policy associated with the generative AI model, and the partition function and zeroing the partition function includes zeroing the partition function with respect to the relationship.

In some examples of the method, application servers, and non-transitory computer-readable medium described herein, fine-tuning the set of weights may include operations, features, means, or instructions for reducing a difference between the explicit reward model and the implicit reward model based on the comparison of the explicit reward model and the implicit reward model.

In some examples of the method, application servers, and non-transitory computer-readable medium described herein, the comparison includes a mean-squared error comparison or a binary cross entropy comparison and fine-tuning the set of weights may be based on a reduction in the mean-squared error comparison or a binary cross entropy comparison.

Some examples of the method, application servers, and non-transitory computer-readable medium described herein may further include operations, features, means, or instructions for generating the explicit reward model based on the feedback data.

In some examples of the method, application servers, and non-transitory computer-readable medium described herein, the feedback data includes a set of multiple feedback prompts and a set of multiple feedback responses to the set of multiple feedback prompts, the preference feedback data includes indications of preferred responses and non-preferred responses of the set of multiple feedback responses, the binary feedback data includes positive indications and negative indications to the set of multiple feedback prompts, positive indications and the negative indications included in the set of multiple feedback responses, and the score feedback data includes scoring information that may be included in the set of multiple feedback responses.

In some examples of the method, application servers, and non-transitory computer-readable medium described herein, fine-tuning the set of weights of the generative AI model in a single pass.

The following provides an overview of aspects of the present disclosure:

Aspect 1: A method for data processing at an application server, comprising: obtaining a generative AI model that is a trained model comprising a set of weights and that is associated with an explicit reward model and an implicit reward model; zeroing a partition function of the implicit reward model associated with the generative AI model; obtaining feedback data associated with the explicit reward model, the feedback data comprising preference feedback data, binary feedback data, score feedback data, or any combination thereof; generating the explicit reward model based at least in part on the feedback data; fine-tuning the set of weights of the generative AI model based at least in part on a comparison of the explicit reward model and the implicit reward model and further based at least in part on the feedback data; receiving, at the generative AI model, a query; and generating, with the generative AI model and based at least in part on the query and the fine-tuned set of weights, a response that is responsive to the query.

Aspect 2: The method of aspect 1, further comprising: tuning the generative AI model and the implicit reward model based at least in part on a relationship between the generative AI model and the implicit reward model.

Aspect 3: The method of aspect 2, wherein the relationship relates the implicit reward model, the generative AI model, a reference policy associated with the generative AI model, and the partition function; and zeroing the partition function comprises zeroing the partition function with respect to the relationship.

Aspect 4: The method of any of aspects 1 through 3, wherein fine-tuning the set of weights comprises: reducing a difference between the explicit reward model and the implicit reward model based at least in part on the comparison of the explicit reward model and the implicit reward model.

Aspect 5: The method of any of aspects 1 through 4, wherein the comparison comprises a mean-squared error comparison or a binary cross entropy comparison; and fine-tuning the set of weights is based at least in part on a reduction in the mean-squared error comparison or the binary cross entropy comparison.

Aspect 6: The method of any of aspects 1 through 5, wherein the feedback data comprises a plurality of feedback prompts and a plurality of feedback responses to the plurality of feedback prompts; the preference feedback data comprises indications of preferred responses and non-preferred responses of the plurality of feedback responses; the binary feedback data comprises positive indications and negative indications to the plurality of feedback prompts, positive indications and the negative indications included in the plurality of feedback responses; and the score feedback data comprises scoring information that is included in the plurality of feedback responses.

Aspect 7: The method of any of aspects 1 through 6, further comprising: fine-tuning the set of weights of the generative AI model in a single pass.

Aspect 8: An application server for data processing, comprising one or more memories storing processor-executable code, and one or more processors coupled with the one or more memories and individually or collectively operable to execute the code to cause the application server to perform a method of any of aspects 1 through 7.

Aspect 9: An application server for data processing, comprising at least one means for performing a method of any of aspects 1 through 7.

Aspect 10: A non-transitory computer-readable medium storing code for data processing, the code comprising instructions executable by one or more processors to perform a method of any of aspects 1 through 7.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing at an application server, comprising:
obtaining a generative artificial intelligence (AI) model that is a trained model comprising a set of weights and that is associated with an explicit reward model and an implicit reward model;
zeroing a partition function of the implicit reward model associated with the generative AI model;
obtaining feedback data associated with the explicit reward model, the feedback data comprising preference feedback data, binary feedback data, score feedback data, or any combination thereof;
generating the explicit reward model based at least in part on the feedback data;
fine-tuning the set of weights of the generative AI model based at least in part on a comparison of the explicit reward model and the implicit reward model and further based at least in part on the feedback data;
receiving, at the generative AI model, a query; and
generating, with the generative AI model and based at least in part on the query and the fine-tuned set of weights, a response that is responsive to the query.

2. The method of claim 1, further comprising:
tuning the generative AI model and the implicit reward model based at least in part on a relationship between the generative AI model and the implicit reward model.

3. The method of claim 2, wherein:
the relationship relates the implicit reward model, the generative AI model, a reference policy associated with the generative AI model, and the partition function; and
zeroing the partition function comprises zeroing the partition function with respect to the relationship.

4. The method of claim 1, wherein fine-tuning the set of weights comprises:
reducing a difference between the explicit reward model and the implicit reward model based at least in part on the comparison of the explicit reward model and the implicit reward model.

5. The method of claim 1, wherein:
the comparison comprises a mean-squared error comparison or a binary cross entropy comparison; and
fine-tuning the set of weights is based at least in part on a reduction in the mean-squared error comparison or the binary cross entropy comparison.

6. The method of claim 1, further comprising:
generating the explicit reward model based at least in part on the feedback data.

7. The method of claim 1, wherein:
the feedback data comprises a plurality of feedback prompts and a plurality of feedback responses to the plurality of feedback prompts;
the preference feedback data comprises indications of preferred responses and non-preferred responses of the plurality of feedback responses;
the binary feedback data comprises positive indications and negative indications to the plurality of feedback prompts, positive indications and the negative indications included in the plurality of feedback responses; and
the score feedback data comprises scoring information that is included in the plurality of feedback responses.

8. The method of claim 1, further comprising:
fine-tuning the set of weights of the generative AI model in a single pass.

9. An application server for data processing, comprising:
one or more memories storing processor-executable code; and
one or more processors coupled with the one or more memories and individually or collectively operable to execute the code to cause the application server to:
obtain a generative artificial intelligence (AI) model that is a trained model comprising a set of weights and that is associated with an explicit reward model and an implicit reward model;
zero a partition function of the implicit reward model associated with the generative AI model;
obtain feedback data associated with the explicit reward model, the feedback data comprising preference feedback data, binary feedback data, score feedback data, or any combination thereof;
generate the explicit reward model based at least in part on the feedback data;
fine-tune the set of weights of the generative AI model based at least in part on a comparison of the explicit reward model and the implicit reward model and further based at least in part on the feedback data;
receive, at the generative AI model, a query; and
generate, with the generative AI model and based at least in part on the query and the fine-tuned set of weights, a response that is responsive to the query.

10. The application server of claim 9, wherein the one or more processors are individually or collectively further operable to execute the code to cause the application server to:
tune the generative AI model and the implicit reward model based at least in part on a relationship between the generative AI model and the implicit reward model.

11. The application server of claim 10, wherein:
the relationship relates the implicit reward model, the generative AI model, a reference policy associated with the generative AI model, and the partition function; and
zeroing the partition function comprises zeroing the partition function with respect to the relationship.

12. The application server of claim 9, wherein, to fine-tune the set of weights, the one or more processors are individually or collectively operable to execute the code to cause the application server to:
reduce a difference between the explicit reward model and the implicit reward model based at least in part on the comparison of the explicit reward model and the implicit reward model.

13. The application server of claim 9, wherein:
the comparison comprises a mean-squared error comparison or a binary cross entropy comparison; and
fine-tuning the set of weights is based at least in part on a reduction in the mean-squared error comparison or the binary cross entropy comparison.

14. The application server of claim 9, wherein:
the feedback data comprises a plurality of feedback prompts and a plurality of feedback responses to the plurality of feedback prompts;
the preference feedback data comprises indications of preferred responses and non-preferred responses of the plurality of feedback responses;
the binary feedback data comprises positive indications and negative indications to the plurality of feedback prompts, positive indications and the negative indications included in the plurality of feedback responses; and
the score feedback data comprises scoring information that is included in the plurality of feedback responses.

15. The application server of claim 9, wherein the one or more processors are individually or collectively further operable to execute the code to cause the application server to:
fine-tune the set of weights of the generative AI model in a single pass.

16. A non-transitory computer-readable medium storing code for data processing, the code comprising instructions executable by one or more processors to:
obtain a generative artificial intelligence (AI) model that is a trained model comprising a set of weights and that is associated with an explicit reward model and an implicit reward model;
zero a partition function of the implicit reward model associated with the generative AI model;
obtain feedback data associated with the explicit reward model, the feedback data comprising preference feedback data, binary feedback data, score feedback data, or any combination thereof;
generate the explicit reward model based at least in part on the feedback data;
fine-tune the set of weights of the generative AI model based at least in part on a comparison of the explicit reward model and the implicit reward model and further based at least in part on the feedback data;
receive, at the generative AI model, a query; and
generate, with the generative AI model and based at least in part on the query and the fine-tuned set of weights, a response that is responsive to the query.

17. The non-transitory computer-readable medium of claim 16, wherein the instructions are further executable by the one or more processors to:
tune the generative AI model and the implicit reward model based at least in part on a relationship between the generative AI model and the implicit reward model.

18. The non-transitory computer-readable medium of claim 17, wherein:
the relationship relates the implicit reward model, the generative AI model, a reference policy associated with the generative AI model, and the partition function; and
zeroing the partition function comprises zeroing the partition function in the relationship.

19. The non-transitory computer-readable medium of claim 16, wherein the instructions to fine-tune the set of weights are executable by the one or more processors to:
reduce a difference between the explicit reward model and the implicit reward model based at least in part on the comparison of the explicit reward model and the implicit reward model.

20. The non-transitory computer-readable medium of claim 16, wherein:
the comparison comprises a mean-squared error comparison or a binary cross entropy comparison; and
fine-tuning the set of weights is based at least in part on a reduction with respect to the mean-squared error comparison.
